(19) United States
(12) Patent Application Publication
(10) Pub. No.: US 2023/0419120 A1
(43) Pub. Date: Dec. 28, 2023

(54) LEARNING METHOD, ESTIMATION METHOD, LEARNING APPARATUS, ESTIMATION APPARATUS, AND PROGRAM

(71) Applicant: NIPPON TELEGRAPH AND TELEPHONE CORPORATION, Tokyo (JP)

(72) Inventor: Tomoharu IWATA, Tokyo (JP)

(21) Appl. No.: 18/247,348

(22) PCT Filed: Oct. 5, 2020
(86) PCT No.: PCT/JP2020/037716

§ 371 Date: Mar. 30, 2023

(51) Int. Cl. G06N 3/0895

(52) U.S. Cl. CPC G06N 3/0895

(57) ABSTRACT

A learning method according to an embodiment causes a computer to execute: an input step of inputting a plurality of data sets; and a learning step of learning, based on the plurality of input data sets, an estimation model for estimating a parameter of a topic model from a smaller amount of data than an amount ot data included in the plurality of data sets.

### TECHNICAL FIELD

The present invention relates to a learning method, an estimation method, a learning device, an estimation device, and a program.

### BACKGROUND ART

Topic model (see, fur example, Non Patent Literature 1) is a method for analyzing discrete data, and its usefulness has been confirmed in various applications such as document analysis, purchase analysis, time series analysis, information search, and visualization.

### CITATION LIST

### Non Patent Literature

Non Patent Literature 1: Blei, David M.; Ng, Andrew Y.; Jordan, Michael I (January 2003) “Latent Dirichlet, Allocation”. Journal of Machine Learning Research 3 (45): pp. 993022.

### SUMMARY OF INVENTION

### Technical Problem

However, a topic model has a problem that a large amount of data is required for learning (that is, parameter estimation)

An embodiment of the present invention has been made in view of the above problem, and an oblect thereof is to enable learning of a topic model even from a small amount of data.

### Solution to Problem

In order to achieve the above objet, a learning method according to an embodiment causes a computer to execute: an input step of inputting a plurality of data sets; and a learning of learning, based on the plurality of input data sets, a estimation model for estimating a parameter of a topic model from a smaller amount of data than an amount of data inclucded in the plurality of data sets.

### Advantageous Effects of Invention

A topic model can be learned from even a small amount of data.

### BRIEF DESCRIPTION OF DRAWINGS

FIG. 1 is a diagram illutrating an example of a functional configuration of a parameter estimation device according to the present embodiment.

FIG. 2 is a flowchart illustrating an example of learning processing according to the present embodiment.

FIG. 3 is a flowchart illustrating an example of estimation processing according to the present embodiment.

FIG. 4 is a diagram illustrating an example of a hardware configuration of the parameter estimation device according to the present embodiment.

### DESCRIPTION OF EMBODIMENTS

Hereinafter, an embodiment of the present invention will be described. In the present embodiment, a parameter estimation device 10 capable of learning a topic model (that is, estimating parameters of a topic model) even from a small amount of data will be described. However, the topic model is an example, and the present invention is similarly applicable to, for exampl, a case of estimating parameters of other mixture models such as a mixed Gaussian distribution and a mixed Poisson distribution.

Here, the parameter estimation device 10 according to the present embodiment has a learning phase and an estimation phase, and in the learning phase, a plurality of pieces of data (generally a large amount of data) is provided as input data. By use of the input data, the parameter estimation device 10 learns parameters of a model (hereinafter, also referred to as “estimation model”) for estimating the parameters of the topic model (hereinafter, also referred to as “topic model parameters”). Meanwhile, in the estimation phase, a small amount of data is given and the topic model parameters are estimated by use of the learned estimation model. Note that the parameter estimation device 10 in the learning phase may be referred to as, for example, “learning device” or the

Hereinafter, as an example, assumed that document analysis is performed the topic model, and the parameter estimation device 10 in the learning phase is given D ocument sets

{X_{d}}_{d=1}^{D} [Math. 1]

as input data. Here,

X_{d}={a_{dn}}ₙ₌₁^{N}^{_{d}} [Math. 2]

is a d-th document set, N_{d} the number of documents included in the d-th document set, and

x_{dn}=(x_{dnj})ⱼ₌₁^{J} [Math. 3]

is a word frequency vector of an n-th document included in the d-th document set. In addition, x_{dnj} is the frequency of j-th word, and J is the number of vocabularies (that is, the number of types of words). Note that, hereinafter, the n-th document is also referred to as “document n”, and the j-th word is also referred to as “word j”.

Meanwhile, it is assumed that the parameter estimation device 10 in the estimation phase is given a document set including word frequency vectors of a small number of documents as input data.

Note that, in the present embodiment, it is assumed that the input data is data related to documents on the assumption that document analysis is performed by the topic model, but the present invention is not limited thereto, and various types of data are used as input data according to an object to be analyzed by the topic model. For example, in a case where purchase analysis is performed he the topic model, data related to a purchase history is used as input data.

### Functional Configuration

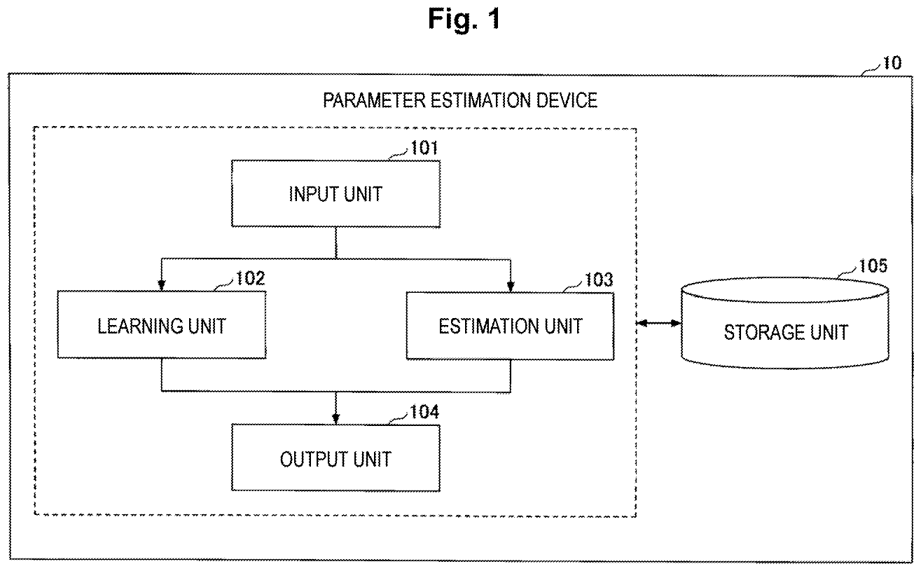

First, a functional configuration of the parameter estimation device 10 according to the present embodiment will be described with reference to FIG. 1. FIG. 1 is a diagram illustrating an example of the functional configuration of the parameter estimation device 10 according to the present embodiment.

As illustrated in FIG. 1, the parameter estimation devide 10 according to the present embodiment includes an inpu, unit 101, a learning unit 102, an estimation unit 103, an output unit 104, and a storage unit 105.

The storage unit 105 stores various types of data used in he learning phase and the estimation phase. That is, the storage unit 105 stores input data given in the learning phase and the estimation phase, parameters of an estimation model, and the like.

In the learning phase, the input unit 101 inputs D document sets {X₁, . . . , X_{D}} as input data from the storage unit 105. Furthermore, the estimation phase, the input unit 101 inputs, from the storage unit 105, a document set including word frequency vectors of a small number of documents as input data.

The learning unit 102 executes learning processing in the learning phase. In the learning processing, the parameters of the estimation model are learned by use of the input data input by the input unit 101. Note that details of the learning processing will be described later.

The estimation unit 103 executes estimation processing in the estimation phase. In the estimation processing, topic model parameters are estimated by the learned estimation model using the input data input by the input unit 100. Note that details of the estimation processing will be described later.

The output unit 104 outputs the parameters of the estimation model learned by the learning unit 102. Furthermore, the output unit 104 outputs the topic model parameters estimated b the estimation unit 103. Note that an output destination of the output unit 104 may be any predetermined output destination, and example thereof include the storage unit 105, a display, and another device, apparatus, terminal, or the like connected via a communication network.

Note that the functional configuration of the parameter estimation device 10 illustrated in FIG. 1 is a functional configuration for both the learning phase and the estimation phase, and for example, the parameter estimation device 10 in the learning phase does not have to include the estimation unit 103. Similarly, for example, the parameter estimation device 10 in the estimation phase does not have to include the learning unit 102.

Furthermore, the parameter estimation device 10 the learning phase and the parameter estimation device 10 in the estimation phase may be implemented by different devices, apparatuses, or terminals. For example, a first device and a second device may be connected via a communication network, and the parameter estimation device 10 in the learning phase may be implemented by the first device while the parameter estimation device 10 in the estimation phase may be implemented by the second device.

### Learning Processing

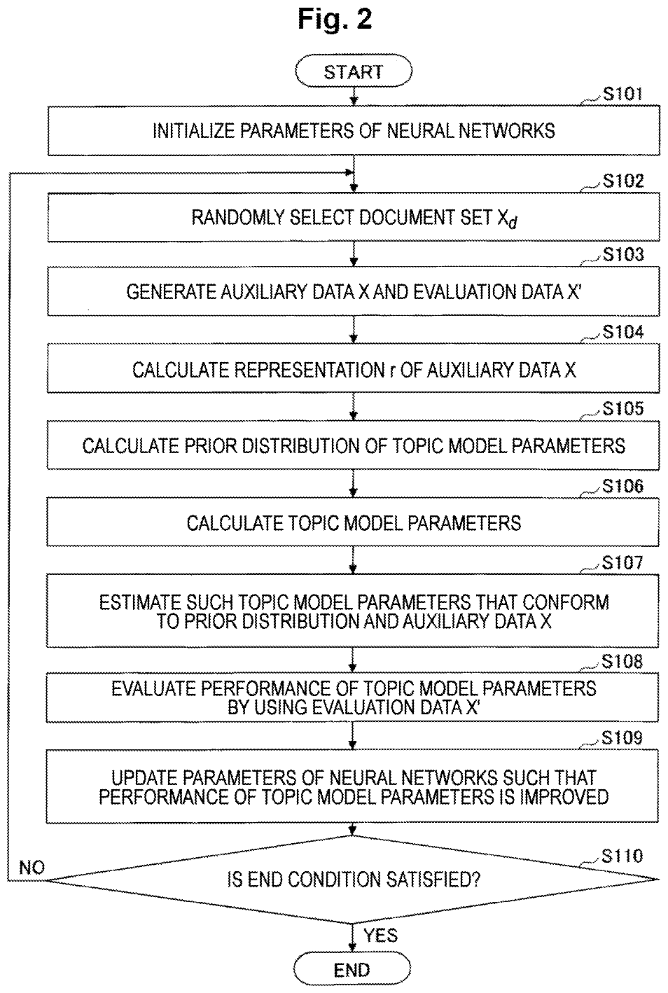

Next, the learning processing according to the present embodiment will be described with reference to FIG. 2. FIG. 2 is a flowchart illustrating an example of the learning processing according to the present embodiment. Note that, hereinafter, it is assumed that the input unit 101 inputs, from the storage unit 105, D documents sets {X₁, . . . , X_{D}} as input data. In addition, the estimation model is assumed to include neural networks, as an example.

Step S101: First, the learning unit 102 initializes parameters of neural networks included in the estimation model. Note that the parameters of the neural networks may be initialized by a known initialization method.

Step S102: Next, the learning unit 102 selects one document set X_{d} by randomly selecting d ∈ {1, . . . , D}.

Step S103: Next, the learning unit 102 generates auxiliary data X and evaluation data X′ from the document set X_{d} selected in step S102 described above. The auxiliary data is data for generating the topic model parameters, and the evaluation data is data for evaluating the generated topic model parameters.

Here, each of the auxiliary data X and the evaluation data X′ is a set including word frequency vectors of N documents (where N≤N_{d}). In addition, a word frequency vector xₙ of the document included in the auxiliary data X and a word frequency vector x′ₙ of the document n included in the evaluation data X′ are generated by randomly distributing the frequency of the same word in the word frequency vector of the same document as the document n included in the document set X_{d}. Specifically, assuming that a word frequency vector of the same document as the document n included in the document set X_{d} is also expressed as x_{dn}, the word frequency vectors xₙ and x′ₙ are generated by randomly distributing a frequency x_{dnj} of the word j included in x_{dn} to a frequency xₙⱼ of the word j included in xₙ and a frequency x′ₙⱼ of the word j included in x′ₙ for each j=1, . . . , J. That is, for each n and each j, x_{dnj}=xₙⱼ+x′ₙⱼ (where xₙⱼ≥0, x′ₙⱼ≥0) is established.

In this manner, the auxiliary data X and the evaluation data X′ are generated by randomly distributing the frequencies of the word frequency vectors of all or some of the documents included in the document set X_{d} for each document and for each word.

Step S104: Next, the learning unit 102 calculates representation r of the auxiliary data X by using the auxiliary data X generated in step S103 described above and neural networks constituting a part of the estimation model. Note that his representation r depends on the auxiliary data X.

For example, the learning unit 102 can calculate the representation r of the auxiliary data X by the following Formula (1).

$$[ Math . 4 ]$$

$$r = {g}_{R} ( \frac{1}{N} {\sum }_{n = 1}^{N} {f}_{R} ( {x}_{n} ) ) \qquad ( 1 )$$

Here, f_{R} and g_{R} are neural networks. Furthermore, X={x₁, . . . , x_{N}}.

Step S105: Next, the learning unit 102 calculates a prior distribution of the topic model parameters by using the auxiliary data X generated in step S103 described above, the representatron r calculated in step S104 described above, and neural networks constituting a part of the estimation model.

The learning unit 102 can calculate the prior distribution of the topic model parameters by, for example, the following Formulas (2) and (3).

### [Math. 5]

αₙ=f_{A}([xₙ, r]) (2)

βₖ=f_{B}([X^{T}αₖ, r]) (3)

Here, f_{A} and f_{B} are neural networks, and [.,.] represents a combination of vectors. In addition, assuming k=1, . . . , K and j=1, . . . , J, αₙ=(αₙₖ), βₖ=(βⱼₖ) is established, and as described later, k represents a topic and K represents the number of topics.

Step S106: Next, the learning unit 102 calculates the topic model parameters by using the prior distribution calculated in step S105 described above.

The learning unit 102 can calculate the topic model parameters by, for example, the following Formulas (4) and (5).

$$[ Math . 6 ]$$

$${θ}_{nk} = \frac{{α}_{nk}}{{\sum }_{{k}^{′} = 1}^{K} {α}_{{nk}^{′}}} \qquad ( 4 )$$

$${ϕ}_{kj} = \frac{{β}_{jk}}{{\sum }_{{j}^{′} = 1}^{J} {β}_{{j}^{′} k}} \qquad ( 5 )$$

Here, θₙₖ and φₖⱼ represents the topic model parameters.

Step S107: Next, the learning unit 102 estimates such topic model parameters that conform to the prior distribution calculated in step S105 described above and the auxiliary data X generated in step S103 described above.

The learning unit 102 can estimate the topic model parameters by, for example, likelihood, maximization, posterior probability maximization, variational Bayesian estimation, posterior probability estimation, or the like. Hereinafter, as an example, a case of estimating the topic model parameters by posterior probability maximization will be described. Tn the case of estimating the topic model parameters by posterior probability maximization, updating the topic model parameters by use of an expectation maximization (EM) algorithm makes it possible to obtain topic model parameters that maximize the posterior probability.

Specifically, first, in the E step, the learning unit 102 calculates the contribution rate of each word by the following Formula (6).

$$[ Math . 7 ]$$

$${γ}_{njk} = \frac{{θ}_{nk} {ϕ}_{kj}}{{\sum }_{{k}^{′} = 1}^{K} {θ}_{{nk}^{′}} {ϕ}_{{k}^{′} j}} \qquad ( 6 )$$

Here, Yₙⱼₖ represents a probability that the word j belongs to a topic k in the document n. Next, in the M step, the learning unit 102 updates the topic model parameters by the following Formulas (7) and (8).

$$[ Math . 8 ]$$

$${θ}_{nk} = \frac{{\sum }_{j = 1}^{J} {x}_{nj} {γ}_{njk} + {α}_{nk}}{{\sum }_{{k}^{′} = 1}^{K} ( {\sum }_{j = 1}^{J} {x}_{nj} {γ}_{{njk}^{′}} + {α}_{{nk}^{′}} )} \qquad ( 7 )$$

$${ϕ}_{kj} = \frac{{\sum }_{n = 1}^{N} {x}_{nj} {γ}_{njk} + {β}_{jk}}{{\sum }_{{j}^{′} = 1}^{J} ( {\sum }_{n = 1}^{N} {x}_{{nj}^{′}} {γ}_{{nj}^{′} k} + {β}_{{j}^{′} k} )} \qquad ( 8 )$$

The learning unit 102 repeatedly executes the E step and the M step until a predetermined first end condition is satisfied. With this processing, it is possible to obtain estimation values of the topic model parameters shown as follows.

{{θₙₖ}ₖ₌₁^{K}}ₙ₌₁^{N}, {{ϕₖⱼ}ⱼ₌₁^{J}}ₖ₌₁^{K} [Math. 9]

Here, k represents a topic, and K represents the number of topics.

Note that, as the predetermined first end condition, it is possible to use, for example, a condition that the number of repetitions of the E step and the M step has exceeded a predetermined first threshold, a condition that the amount of change or the like in the topic model parameters before and after the repetition has become equal to or less than a predetermined second threshold, or the like.

Step S108: Next, the learning unit 102 evaluates the performance of a topic model having the topic model parameters estimated in step S103 described above by using the evaluation data X′ generated in step S107 described above.

As an evaluation index for evaluating the performance of the topic model, for example, test likelihood or the like can be uaed. In this case, for example, the learning unit 102 can execute steps S104 to S107 described above by using the evaluation data X′ instead of the auxiliary data X, calculate the contribution rate shown in the: above Formula (6), and calculate the log likelihood or the like of the contribution rate.

Step S109: Next, the learning unit 102 updates the parameters of the neural networks (for example, f_{R}, g_{R}, f_{A} and f_{B}) constituting the estimation model such that the performance of the topic model evaluated in step S108 described above is improved. Note that the learning unit 102 can update the parameters of the neural networks constituting the estimation model by using, for example, a known method such as a stochastic gradient descent method. Since this learning processing, which includes the EM algorithm in step S107 described above, can be differentiated, it is possible to update the parameters of the neural networks such that the performance of the topic model is improved by the back propagation.

Step S110: Next, the learning unit 102 determines whether a predetermined second end condition is satisfied. In a case where it is determined that the end condition is not satisfied, the learning unit 102 returns to Step S102 described above. As a result, steps S102 to S109 described above are repeatedly executed until the end condition is satisfied.

On the other hand, in a case where is determined that the end condition is satisfied. the learning unit 102 ends the learning processing. As a result, the parameters of the learned estimation model are output by the output unit 104.

Note that, as the predetermined second termination condition, for example, it is possible to use a condition that the number of repetitions of steps S102 to S109 described above exceeds a predetermined third threshold, a condition that the amount of change or the like in the parameters of the estimation model before and after the repetition becomes equal to or less than a predetermined fourth threshold, or the like.

As described abo the parameter estimation device in the learning phase can learn the estimation model for estimating the topic model parameters. This learning makes it possible to estimate the topic model parameters (that is, learn the topic model) from a small amount of data in the estamation processing to be described later.

### Estimation Processing

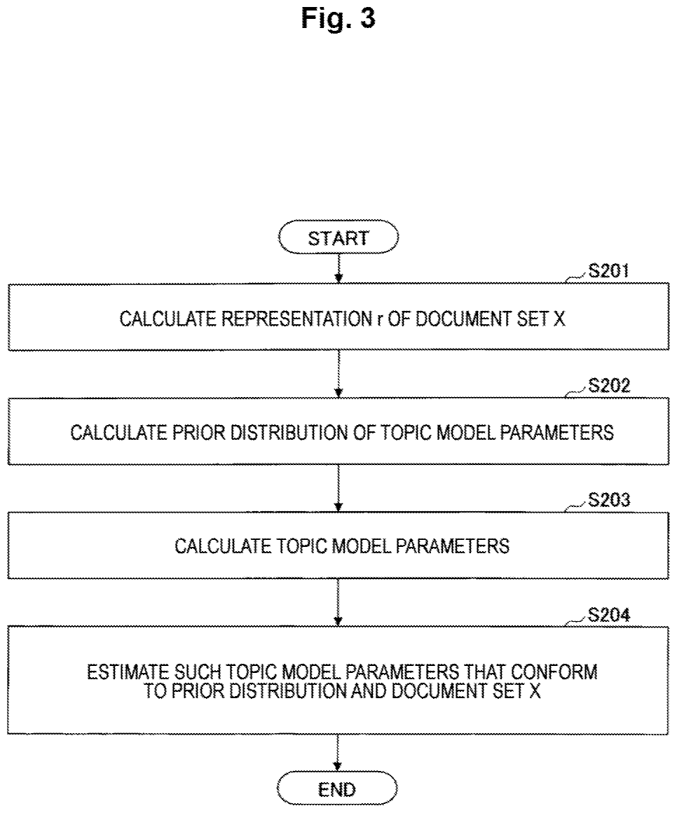

Next, the estimation processing according to the present embodiment will be described with reference to FIG. 3. FIG. 3 is a flowchart illustrating an example of the estimation processing according to the present embodiment. Note that, hereinafter, it is assumed that the input unit 101 inputs, from the storage unit 105, a document set including word frequency vectors of a small number of documents as input data. Note that, in the estimation processing, the document set input as input data is used instead of the auxiliary data in the learning processing. Therefore, hereinafter, the document set (input data) input by the input unit 101 is referred to as “document set X”.

S201: First, the estimation unit 103 calculates the representation r of the auxiliary data X by using document set X and neural networks constituting a part of the learned estimation model, similarly to step S104 in FIG. 2.

Step S202: Next, the estimation unit 103 calculates a prior distribution of the topic model parameters by using the document set X, the representation r calculated in step S201, and neural networks constituting a part of the learned estimation model, similarly to step S105 in FIG. 2.

Step S203: Next, the estimation unit 103 eacalculates the topic model parameters using the prior distribution calculated in step S202 described above, similarly to step S106 in FIG. 2.

Step S204: The estimation unit 103 then estimates such tonic model parameters that conform to the prior distribution calculated in step S203 and the document set X, similarly to step S107 in FIG. 2. As a result, the topic model parameters are output by the output unit 104.

As described above, the parameter estimation device 10 in the estimation phase can estimate the topic model parameters by the estimation model learned in the learning phase by using the document set including the word frequency vectors of the small number of documents as input data. This configuration makes it possible to perform various analyses by a topic model even in a case where only a small amount of data is given.

### Evaluation

Next, evaluation results of a topic model parameter estimation method (hereinafter, referred to as “proposed method”) by the parameter estimation device 10 according to the present embodiment will be described. In order to evaluate the proposed method, topic model parameters were estimated (that is, a topic model learned) by use of three sets of data of news articles 20 News, social service articles Digg, and international conference papers NeurIPS, and a result thereof was compared with an existing method. Test perplexity was used as an evaluation index. The comparison results are show in Table 1 below. Note that a lower test perplexity indicates better performance.

TABLE 1

| | 20 News | Digg | NeurIPS |
|---|---|---|---|
| Proposed method | 2785.8 ± 67.0 | 556.1 ± 9.7 | 606.7 ± 6.7 |
| LDAind | 3239.1 ± 88.0 | 613.4 ± 13.2 | 636.2 ± 9.0 |
| LDAall | 3542.8 ± 98.8 | 631.7 ± 27.6 | 926.8 ± 9.9 |

Here, in Table 1, LDAind represents an existing topic model learned by use of only a small amount of data, and LDAall represents an existing topic model learned by use of all data.

As shown in Table 1 above, it can be seen that the proposed method achieves higher performance than the existing method.

### Hardware Configuration

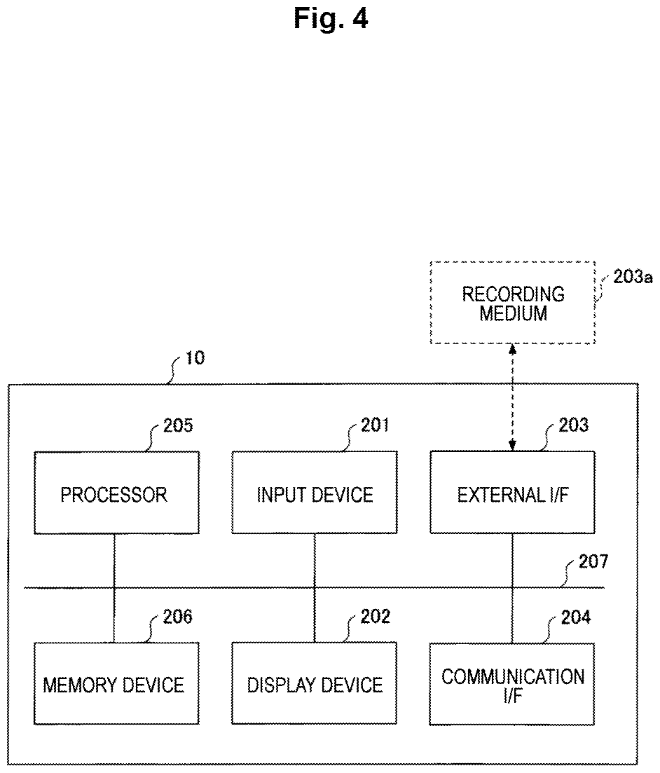

Finally, a hardware configuration of the parameter estimation device 10 according to the present embodiment will be described with reference to FIG. 4. FIG. 4 is a diagram illustrating an example of the hardware configuration of the parameter estimation device 10 according to the present embodiment.

As illustrated in FIG. 4, the parameter estimation device 10 according to the present embodiment is implemented by a hardware configuration of a general computer or computer system, and includes an input device 201, a display device 202, an external I/F 203, a communication I/F 204, a processor 205, and a memory device 206. These pieces of hardware are communicably connected via a bus 207.

The input device 201 , for example, a keyboard, a mouse, a touch panel, or the like. The display device 202 is, for example, a display or the like. Note that the parameter estimation device 10 does not have to include at least one of the input device 201 and the display device 202, for example.

The external I/F 203 is an interface with external device such as a recording medium 203a. The parameter estimation device 10 can read from and write in the recording medium 203a via the external I/F 203. The recording medium 203a may store, for example, one or more programs for implementing each functional unit (the input unit 101, the learning unit 102, the estimation unit 103, and the output unit 104) included in the parameter estimation device 10.

Note that. the rewording medium 203a includes, for example, a compact disc (CD), a digital versatile disk (DVD), a secure digital memory card (SD memory card), a universal serial bus (USB) memory card, and the like.

The communication I/F 254 is an interface for connecting the parameter estimation device 10 to a communication network. Note that one or more programs for implementing each functional included in the parameter estimation device 10 may be acquired (downloaded) from a predetermined server device or the like via the communication I/F 204.

The processor 205 is, for example, an arithmetic device of various types such as a central processing unit (CPU) and a graphics processing unit (GPU). Each functional unit included in the parameter estimation device 10 is implemented for example, by processing executed by the procesor 205 by one or more programs stored in the memory device 206 or the like.

The memory device 206 is, for example, a storage device of various types such as a hard disk drive (HDD), a solid state drive (SSD), a random access memory (RAM), a read only memory (ROM), and a flash memory. The storage unit 105 included in the parameter estimation device 10 can be implemented by use of, for example, the memory device 206. Note that the storage unit 105 may implemented by use of, for example, a storage dPvice or the like connected to the parameter estimation device 10 via a communication network.

The parameter estimation device 10 according to the present embodiment has the hardware configuration illustrated in FIG. 4, thereby being able to implement the above-described learning processing and estimation processing. Note that the hardware configuration illustrated in FIG. 4 is an example, and the parameter estimation device 10 may have another hardware configuration. For example, the parameter estimation device 10 may include a plurality of processors 205 or a plurality of memory devices 206.

The present invention is not limited to the specifically disclosed embodiment, and various modifications and changes, combinations with known techniques, and the like can be made without departing from the scope of the claims.

### REFERENCE SIGNS LIST

10 Parameter estimation device
101 Input unit
102 Learning unit
103 Estimation unit
104 Output unit
105 Storage unit
201 Input device
202 Display device
203 External I/F
203a Recording medium
204 Communication I/F
205 Processor
206 Memory device
207 Bus

1. A learning method executed by a computer, the learning method comprising:
inputting, a plurality of data sets; and
learning based on the plurality of input data sets an estimation model for estimating, a parameter of a topic model from a smaller amount of data than an amount of data included in the plurality of data sets.

2. The learning method according to claim 1, wherein the learning includes
generating a first data set for estimating the parameter of the topic model and a second data set for evaluating the parameter of the topic model based on one data set included in the plurality of data sets,
an estimation step of estimating the parameter of the topic model, the parameter of the topic model conforming, to the first data set and a prior distribution of the parameter of the topic model,
evaluating performance of the topic model having the estimated parameter based on the second data set, and
updating a parameter of the estimation model based on the evaluation to improve the performance of the topic model.

3. The learning method according to claim 2, wherein
the estimation model includes at least a first neural network and a second neural network,
the learning includes
calculating a representation of the first data set by the first neural network based on the first data set, and
calculating the prior distribution by the second neural network based on the first data set and the representation, and
the update updating includes
updating the parameter of the estimation model including a parameter of the first neural network and a parameter of the second neural network.

4. The learning method according to claim 2, wherein generating includes
generating the first data set and the second data set by setting a first value and a second value obtained by randomly dividing a value of data included in the one data set as a value of data included in the first data set and a value of data included in the second data set, respectively.

5. An estimation method executed by a computer, the estimation method comprising:
inputting a data set; and
estimating, based on the input data set, a parameter of a topic model by an estimation model learned in advance by use of a plurality of data sets including a larger amount of data than an amount of data included in the data set.

6. A learning device comprising:
a processor; and
a memory that includes instructions, which when executed, cause the processor to execute:
inputting a plurality of data sets; and
learning, based on the plurality of input data sets, an estimation model for estimating a parameter of a topic model from a smaller amount of data than an amount of data included in the plurality of data sets.

7. (canceled)

8. A non-transitory, computer-readable recording medium storing a program that causes a computer to execute the learning method according to claim 1.
